(19) United States
(12) Patent Application Publication
(10) Pub. No.: US 2026/0193900 A1
(43) Pub. Date: Jul. 9, 2026

(54) INFLATABLE STRUCTURE AND METHOD FOR PRODUCING AN INFLATABLE STRUCTURE

(71) Applicant: COMPAGNIE GENERALE DES ETABLISSEMENTS MICHELIN, Clermont-Ferrand (FR)

(72) Inventors: PIERRE-JOSEPH THIEBEAULD-DE-LA-CROUEE, Clermont-Ferrand (FR); ARMEL MBIAKOP NGASSA, Clermont-Ferrand (FR); ARNAUD DE-GAYFFIER, Clermont-Ferrand (FR)

(21) Appl. No.: 19/132,102

(22) PCT Filed: Oct. 26, 2023
(86) PCT No.: PCT/EP2023/079909

§ 371 Date: May 22, 2025

(30) Foreign Application Priority Data
Nov. 22, 2022 (FR) FR2212139

(51) Int. Cl. E04H 15/20

(52) U.S. Cl. CPC E04H 15/20

(57) ABSTRACT

An inflatable structure (1) comprises an inflatable tubular stiffening member (2) having a shape of revolution about a central axis (X-X′), the tubular stiffening member (2) being made from an airtight film the edges of which on two opposite sides are joined using axial sealing means (4) such that a tube (3) is formed when the film is folded up on itself and the axial sealing means (4) are assembled, and the tube being open at its axial ends (5, 6). The tubular stiffening member comprises circumferential sealing means (7) arranged such that an outer air chamber (6) of annular cross section is formed when the tube (3) is turned back on itself and when the two axial ends (5) and (6) of the tube (3) are assembled using the circumferential sealing means (7).

The present invention relates to the field of inflatable structures, more particularly of the type comprising at least one inflatable stiffening member forming part of the framework of enclosures, shelters or tents when it is covered with a canvas, or comprising one or more inflatable stiffening members used in the manufacture of furniture or floating objects.

In this field, inflatable structures which comprise a frame comprising inflatable stiffening members in a fabric cover are known. The stiffening members are fitted with inflation valves. After inflation, the stiffening members ensure stiffening of the frame. These structures are generally self-supporting; once inflated, they hold their shape and support coverings or doors, in the case of enclosures or shelters, or they support trays or other furnishings, in the case of furniture, such as inflatable seats or tables.

Such a tubular stiffening member is obtained by rolling a film made of a polymer material on itself, then connecting the two longitudinal edges with a longitudinal weld to obtain an open tube, followed by two welds at the ends to close the tube. However, due to the way in which it is manufactured, such an inflatable tubular stiffening member tends to have curved ends. However, for certain applications, an inflatable stiffening member having flat ends is preferred in order to ensure more stable support for the structure it supports, as well as better assembly of the inflatable stiffening member with an object having a flat surface, such as a tray.

It is also desirable to incorporate new functionalities in such an inflatable stiffening member so that it can be used in different structures, and also to facilitate its assembly in the structure or assembly of which it forms part.

Document FR 2584762 discloses inflatable structures comprising cylindrical stiffening members with multiple walls, stiffening members that are closed sealingly at their axial ends using flat, rigid end pieces. Document FR 2683248 describes a frame for an inflatable structure comprising two half-cylindrical stiffening members which are placed against one another on the flattened longitudinal side so as to each form a back-up air chamber in case the other air chamber fails. The structures described in these documents do have inflatable stiffening members with flat ends and reinforced sealing, but at the cost of a complex structure which uses rigid end pieces and complex walls, or even double the number of stiffening members.

It is an aim of the invention to overcome the drawbacks of the aforementioned documents and to provide an original solution for the production of an inflatable structure comprising an inflatable stiffening member which is produced inexpensively, while being reliable in operation, allowing good stability on the ground and improving the assembly of the inflatable stiffening member with other parts of the structure in which it is incorporated.

This aim is achieved by the invention which provides an inflatable structure comprising an inflatable tubular stiffening member having a shape of revolution about a central axis, said tubular stiffening member being made from an airtight film the edges of which on two opposite sides are joined using axial sealing means such that a tube is formed when the film is folded up on itself and the axial sealing means are assembled, the tube being open at its axial ends, characterized in that said tubular stiffening member comprises circumferential sealing means arranged such that an outer air chamber of annular cross section is formed when the tube is turned back on itself and when the two axial ends of the tube are assembled using the circumferential sealing means.

In other words, the invention provides an inflatable structure for the construction of shelters or furniture or floats comprising an inflatable tubular stiffening member having a shape of revolution, made from a flexible tube turned back on itself and closed, for example by welding, adhesive bonding, etc. using circumferential sealing means located at a single location, for example at one of its axial ends, the opposite end being itself already closed as it is formed by the curvature of the walls of the tube which has been turned back on itself. An operation consisting in turning a flexible tube back on itself means an operation in which one of the transverse ends of the tube is moved in translation so that it slides along the tube, inside said tube, in the direction of the other axial end which is kept fixed until the two axial ends are located at the same level (meaning that they are located substantially in the same vertical plane which is perpendicular to the longitudinal direction of the tube). This yields a tubular stiffening member of annular cross section, the length of which has been halved compared to the length of the initial tube. By sealing the axial ends against one another, an air chamber of annular section is obtained.

Thus, it was found that the surface of the axial ends of the air chamber thus obtained was no longer a dome, as in prior art inflatable stiffening members which are cylindrical stiffening members closed at each of their two axial ends, but a ring, which proves advantageous when assembled with a flat surface and which has better flat support.

This results in an air chamber the axial end surfaces of which are rings, produced from an initial flexible film or a flexible tube and with minimal assembly operations by welding, adhesive bonding, etc. which are very time-consuming and involve high labour costs. Moreover, since the volume of such a tubular air chamber is slightly smaller than that of a full tube, it inflates more quickly.

Another advantage of such an air chamber of annular section is that it is empty at the centre, which allows other means and/or functions to be integrated therein.

Said film may be transparent. Transparent film means a film transparent to visible light. This makes the inside of the tubular stiffening member visible through the transparent film which encloses the outer air chamber.

Said outer air chamber may surround an inner space which is open at at least one of its axial ends.

Said inner space may be adapted to receive a support member.

Said inner space may be adapted to receive an electrical device.

Said outer air chamber may surround an inner space which may be closed airtightly in such a way as to form an inner air chamber.

Said outer air chamber and said inner air chamber may be inflatable independently.

Said film may be a polyurethane-based film or a polyurethane-coated fabric.

The aim of the invention is also achieved with a method of assembling an inflatable tubular structure comprising an inflatable tubular stiffening member, having a shape of revolution about a central axis, comprising:
a step of making a tube made from an airtight film, the tube being formed when the film is folded up on itself and the edges of the film are assembled using axial sealing means, the tube being open at its axial ends, and
a step of making an outer air chamber of annular cross section which is formed when the tube is turned back on itself and when the two axial ends of the tube are assembled using the circumferential sealing means.

In one variant of the method, at least one support and/or lighting member may be placed inside an inner space which is open at at least one of its transverse ends, said inner space being delimited by said outer air chamber.

In another variant embodiment of the method of the invention, said inner space may be closed sealingly in such a way as to form an inner air chamber.

Said film may be a polyurethane-based film or a polyurethane-coated fabric and the assembly of said sealing means may be carried out by HF welding.

The invention will be understood more clearly from the remainder of the description, which is based on the following figures:

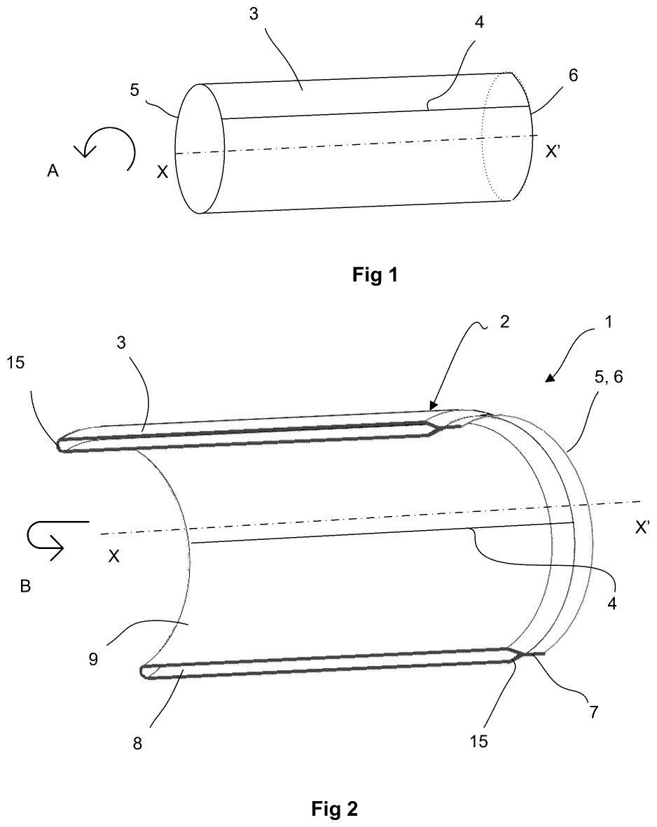

FIG. 1 is a schematic perspective view of a tube used to manufacture the tubular stiffening member of the inflatable structure of the invention;

FIG. 2 is a schematic perspective view of a tubular stiffening member of the inflatable structure of the invention;

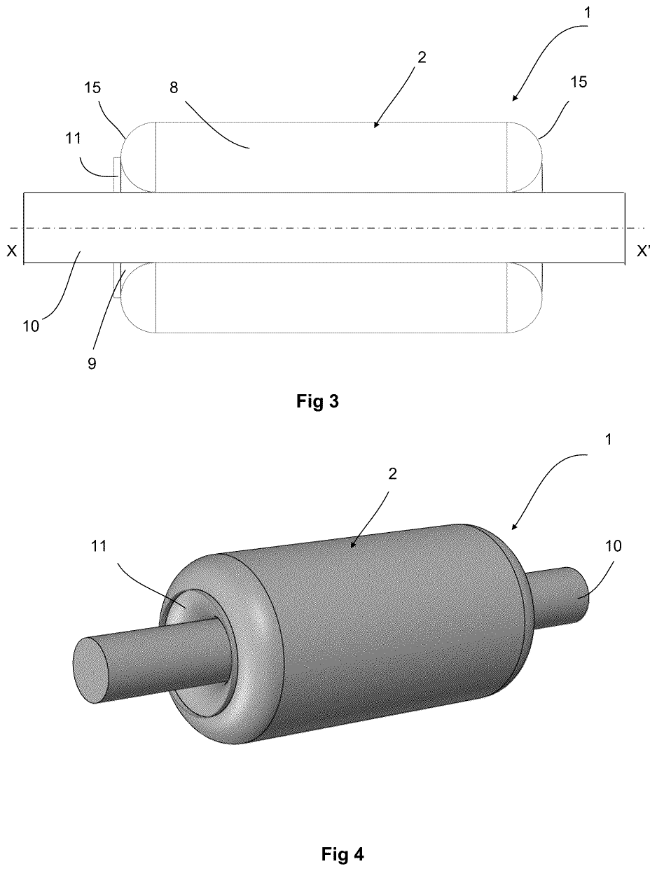

FIG. 3 is an axial sectional view and FIG. 4 is a perspective view of an inflatable structure according to a first variant embodiment of the invention;

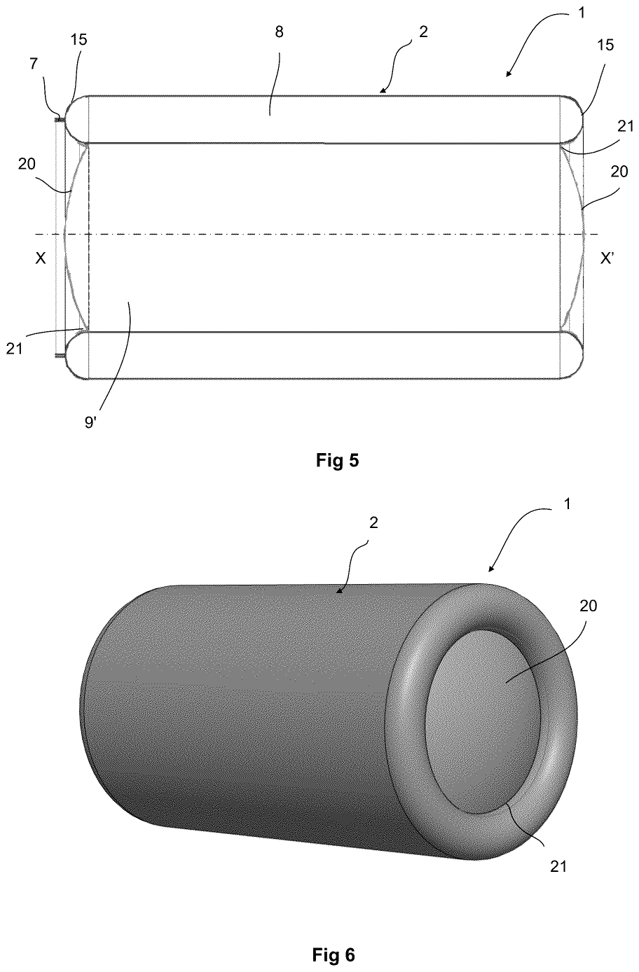

FIG. 5 is an axial sectional view and FIG. 6 is a perspective view of an inflatable structure according to a second variant embodiment of the invention.

In the various figures, identical or similar elements bear the same reference signs. Their description is therefore not systematically repeated.

The inflatable structure 1 of the invention comprises an inflatable tubular stiffening member 2 (FIG. 2) made from an airtight film by successive production and assembly operations, as will be described below.

The tubular stiffening member 2 according to the invention has a substantially cylindrical shape of annular section about an axis of revolution X-X′. This axis of revolution defines three directions conventionally used by those skilled in the art: an axial direction, a circumferential direction and a radial direction.

Axial direction means the direction substantially parallel to the axis of revolution X-X′ of the tubular stiffening member.

Circumferential direction means the direction that is substantially perpendicular both to the axial direction and to a radius of the tubular stiffening member (in other words, tangent to a circle centred on the axis of revolution X-X′ of the tubular stiffening member).

Radial direction means the direction along a radius of the tubular stiffening member, in other words any direction that intersects the axis of revolution X-X′ of the stiffening member and is substantially perpendicular to that axis.

Thus, the sealing means or the parts of the structure which are oriented in one of these directions will be named according to this direction.

FIG. 1 is a simplified perspective view of a flexible tube 3 from which is made a tubular stiffening member 2, as shown in FIG. 2. The tube 3 is made from an airtight film, preferably from a rectangle cut from a reel of flexible film, the opposite edges of the rectangle being curved round, as indicated by the arrow A, then assembled by axial sealing means 4. Axial sealing means 4 refers to an airtight assembly, extending in the axial direction, of the two opposite edges of the rectangle previously cut from the airtight film. Such an assembly may be achieved, for example, by welding or adhesively bonding the edges of the rectangle by bringing one onto the other and superimposing them slightly (by a few mm) for assembly. A flexible tube 3, which is open at its two axial ends 5 and 6, is thus obtained. Alternatively, the tube may be obtained directly by extrusion.

The material of the tube 3 is for example a polyurethane-based thermoplastic film or a polyurethane-coated fabric. The various parts of the film are assembled, for example, by high-frequency welding (HF welding). The thickness of the film used to manufacture the tube 3 is between 100 and 300 μm, preferably between 100 and 160 μm.

Such a film may be, for example, a transparent PLATILON® 4201AU or PLATILON® U 4201 NU polyurethane (ether) film, or a PASCON® TPU 2012 double-sided polyurethane-coated nylon fabric.

According to the invention, the tubular stiffening member 2 is obtained by turning the tube 3 back on itself, in the direction indicated by the arrow B in FIG. 2. More specifically, a first axial end 5 of the tube 3 is taken and slid inside the tube until it comes level with the second axial end 6. When the two axial ends 5 and 6 meet, they are assembled using the circumferential sealing means 7 and an outer air chamber 8 of annular cross section is thus obtained. Circumferential sealing means 7 refers to an airtight assembly, produced for example by welding or by adhesively bonding the two axial ends 5 and 6 of the tube 4 to one another in the circumferential direction. The circumferential sealing means 7 represent the connection or assembly portion of the axial ends 5 and 6, their terminal portions being superimposed over a few mm on their periphery, at the place where they are welded in the circumferential direction. The circumferential sealing means 7 thus produced make it possible to close the outer air chamber 8 such that it is airtight. The outer air chamber 8 thus obtained is provided with an inflation valve (not shown in the drawings) of the type known to those skilled in the art. The tubular stiffening member 2, once inflated (FIG. 2), thus has the shape of a hollow cylinder, and the inner space 9 is free, being delimited by the outer air chamber 8. Note that the surfaces of the axial ends 15 of the tubular stiffening member 2 thus obtained have a circular ring shape, which helps the stiffening member to sit flat.

FIGS. 3 and 4 illustrate a first variant embodiment of an inflatable structure according to the invention. The inflatable structure 1 comprises a tubular stiffening member 2 of the type described above, with reference to FIG. 2, in which a rigid support member 10, for example a shaft or a rod, is inserted in the inner space 9 in such a way as to pass through the stiffening member. The inner space 9 is delimited by the outer air chamber 8 and is closed at one end by a wall 11 for protecting the inner space 9. The wall may be made of the same material as the tubular stiffening member 2.

An inflatable structure according to the variant of FIGS. 3 and 4 may thus be better supported and mounted within an assembly, such as a piece of furniture, to constitute, for example, a headrest, an armrest, or even a seat or part of a seat.

In another variant, not shown in the drawings, the support member 10 is replaced by an electrical device, such as a connection cable or light cable, for example LED. In another variant, the support member 10 is replaced by a bundle of glass fibres. In yet another variant, at least one support member and at least one electrical device are placed inside the inner space 9.

FIGS. 5 and 6 illustrate a second variant embodiment of an inflatable structure according to the invention. The inflatable structure 1 comprises a tubular stiffening member 2 of the type described above, with reference to FIG. 2, in which the inner space 9 is closed sealingly in the vicinity of the two axial ends 15 of the tubular stiffening member. More specifically, a wall 20 is assembled sealingly at each axial end 15 of the tubular stiffening member 2. Such a wall 20 may be made of the same material as the tubular stiffening member and assembled by a weld 21 such as an HF weld to the inner wall of the tubular stiffening member 2.

A sealed inner air chamber 9′ delimited by the inner wall of the outer air chamber 8 and the end walls 20 is thus obtained. Each of the air chambers may be fitted with an inflation valve and be inflated independently of one another. An inflatable structure comprising two separate air chambers is thus obtained, in which the inner air chamber 9′ constitutes a back-up inflatable compartment when the outer air chamber 8 is damaged and deflates. This allows the inflatable structure to generally maintain its shape in the event of a loss of air in one of the chambers.

An inflatable structure according to the variant of FIGS. 5 and 6 may thus be used in the construction of furniture such as a side table or a bar table, or even a stool. Such a structure may also constitute a safety construction beam used for example in the construction of an inflatable enclosure.

For example, the outer air chamber 8 and the inner air chamber 9′ are inflated to the same pressure, which is approximately 0.2 bar. In one variant, the inflation pressure has different values in the inner air chamber and in the outer air chamber.

The inflatable structure in FIGS. 5 and 6 may, in a variant that has not been shown in the drawings, be covered with a fabric cover, for example DACRON®, for example for design or protection purposes.

In yet another variant, the cover is provided with self-gripping or VELCRO® type strips, sewn onto it for assembly with a neighbouring inflatable structure.

Other variants and embodiments of the invention may be envisaged within the scope of the invention as claimed.

1.-12. (canceled)

13. An inflatable structure comprising an inflatable tubular stiffening member having a shape of revolution about a central axis,
the inflatable tubular stiffening member being made from an airtight film, edges of which on two opposite sides are joined using axial sealing means such that a tube is formed when the airtight film is folded up on itself and the axial sealing means are assembled,
the tube being open at two axial ends thereof,
wherein the inflatable tubular stiffening member comprises circumferential sealing means arranged such that an outer air chamber of annular cross-section is formed when the tube is turned back on itself and when the two axial ends of the tube are assembled using the circumferential sealing means.

14. The inflatable structure according to claim 13, wherein the airtight film is transparent.

15. The inflatable structure according to claim 13, wherein the outer air chamber surrounds an inner space which is open at at least one axial end.

16. The inflatable structure according to claim 15, wherein the inner space is adapted to receive a support member.

17. The inflatable structure according to claim 15, wherein the inner space is adapted to receive an electrical device.

18. The inflatable structure according to claim 13, wherein the outer air chamber surrounds an inner space which is closed airtightly in such a way as to form an inner air chamber.

19. The inflatable structure according to claim 18, wherein the outer air chamber and the inner air chamber are inflatable independently.

20. The inflatable structure according to claim 13, wherein the airtight film is a polyurethane-based film or a polyurethane-coated fabric.

21. A method of assembling an inflatable structure comprising an inflatable tubular stiffening member, having a shape of revolution about a central axis and comprising circumferential sealing means, comprising:
a step of making a tube made from an airtight film, the tube being formed when the airtight film is folded up on itself and edges of the film are assembled using axial sealing means, the tube being open at two axial ends; and
a step of making an outer air chamber of annular cross-section which is formed when the tube is turned back on itself and when the two axial ends of the tube are assembled using the circumferential sealing means.

22. The method according to claim 21, wherein at least one support member and/or electrical device is placed inside an inner space which is open at at least one axial end, the inner space being delimited by the outer air chamber.

23. The method according to claim 22, wherein the inner space is closed airtightly in such a way as to form an inner air chamber.

24. The method according to claim 21, wherein the airtight film is a polyurethane-based film or a polyurethane-coated fabric, and
wherein the assembly of the sealing means is carried out by HF welding.
